(19) United States
(12) Patent Application Publication
(10) Pub. No.: US 2015/0247580 A1
(43) Pub. Date: Sep. 3, 2015

(54) Assembly-Free Additively-Manufactured Fluidic Control Elements

(71) Applicant: University of Washington through its Center for Commercialization, Seattle, WA (US)

(72) Inventors: Anthony Au, Seattle, WA (US); Albert Folch, Seattle, WA (US)

(21) Appl. No.: 14/633,680

(22) Filed: Feb. 27, 2015

Related U.S. Application Data
(60) Provisional application No. 61/946,546, filed on Feb. 28, 2014.

(51) Int. Cl. F16K 7/12; F16K 31/126

(52) U.S. Cl. CPC F16K 7/12; F16K 31/126

(57) ABSTRACT

An example fluidic control device may include a flow chamber in fluid communication with a fluid inlet and a fluid outlet, a control chamber in fluid communication with a control channel, and a deflectable membrane positioned between the flow chamber and the control chamber. The fluidic control device may also include a housing surrounding the flow chamber, the control chamber, the fluid inlet, the fluid outlet, the deflectable membrane, and the control channel. The fluidic control device may also include a fluid inlet port in fluid communication with the fluid inlet, a fluid outlet port in fluid communication with the fluid outlet, and a control input port in fluid communication with the control channel. The longitudinal axis of each of the fluid inlet port, the fluid outlet port, and the control input port may be substantially orthogonal to the longitudinal axis of the deflectable membrane.

### CROSS-REFERENCE TO RELATED APPLICATIONS

This application claims the benefit of the filing date of U.S. Provisional Patent Application Ser. No. 61/946,546, filed Feb. 28, 2014, which is hereby incorporated by reference in its entirety.

### GOVERNMENT RIGHTS

This invention was made with government support under grant number R01 NS 064387-02 awarded by the National Institutes of Health. The government has certain rights in the invention.

### BACKGROUND

Unless otherwise indicated herein, the materials described in this section are not prior art to the claims in this application and are not admitted to be prior art by inclusion in this section.

Valves allow for complex functionality and automated operation within fluidic devices. However, the fabrication of membrane-based valves in poly(dimethylsiloxane) (PDMS), the most commonly-used material for microfluidic devices, is quite challenging. In particular, previous systems required assembling an elastomeric membrane within the valve unit, which is typically performed manually and requires precise alignment and skill to fabricate successfully. In part due to the difficulty of fabricating membrane microvalves, their usage and adoption has generally remained limited to specialized microfluidics-focused laboratories. Therefore, an improved valve structure and method of manufacture may be desirable.

### SUMMARY

Example devices and methods described herein describe various fluidic control elements fabricated using an additive-manufacturing technique without need for assembly. The design described herein allows for significant deflection of a deflectable membrane despite the membrane's possible lack of elastic properties. The deflection of the deflectable membrane in turn modulates the flow of fluids through channels, including the ability to completely block off fluid flow in some embodiments. These fluidic control devices are directly scalable to size scales outside the microfluidic range.

Thus, in one aspect, a fluidic control device is provided including (a) a flow chamber in fluid communication with a fluid inlet and a fluid outlet, (b) a control chamber in fluid communication with a control channel, (c) a deflectable membrane positioned between the flow chamber and the control chamber, (d) a housing surrounding the flow chamber, the control chamber, the fluid inlet, the fluid outlet, the deflectable membrane, and the control channel, (e) a fluid inlet port in fluid communication with the fluid inlet, wherein a longitudinal axis of the fluid inlet port is substantially orthogonal to a longitudinal axis of the deflectable membrane, and wherein the longitudinal axis of the deflectable membrane is substantially orthogonal to a line defining a diameter of the deflectable membrane, (f) a fluid outlet port in fluid communication with the fluid outlet, wherein a longitudinal axis of the fluid outlet port is substantially orthogonal to the longitudinal axis of the deflectable membrane, and (g) a control input port in fluid communication with the control channel, wherein a longitudinal axis of the control input port is substantially orthogonal to the longitudinal axis of the deflectable membrane.

In a second aspect, another fluidic control device is provided including (a) a first flow chamber in fluid communication with a fluid inlet, wherein the first flow chamber includes a first interior surface positioned substantially parallel to a second interior surface, (b) a second flow chamber in fluid communication with a fluid outlet, (c) a deflectable membrane positioned between the first flow chamber and the second flow chamber, wherein the deflectable membrane includes one or more perforations such that the first flow chamber is in fluid communication with the second flow chamber, (d) a housing surrounding the first flow chamber, the second flow chamber, the fluid inlet, the deflectable membrane, and the fluid outlet, (e) a fluid inlet port in fluid communication with the fluid inlet, wherein a longitudinal axis of the fluid inlet port is substantially orthogonal to a longitudinal axis of the deflectable membrane, and wherein the longitudinal axis of the deflectable membrane is substantially orthogonal to a line defining a diameter of the deflectable membrane, and (f) a fluid outlet port in fluid communication with the fluid outlet, wherein a longitudinal axis of the fluid outlet port is substantially orthogonal to the longitudinal axis of the deflectable membrane.

In a third aspect, a method is provided for adjusting a rate of fluid flow through a fluidic control device. The method may include (a) receiving fluid flow at a fluid inlet of a fluidic control device, wherein the fluidic control device comprises (i) a flow chamber in fluid communication with the fluid inlet and a fluid outlet, (ii) a control chamber in fluid communication with a control channel, (iii) a deflectable membrane positioned between the flow chamber and the control chamber, (iv) a housing surrounding the flow chamber, the control chamber, the fluid inlet, the fluid outlet, the deflectable membrane, and the control channel, (v) a fluid inlet port in fluid communication with the fluid inlet, (vi) a fluid outlet port in fluid communication with the fluid outlet, and (vii) a control input port in fluid communication with the control channel, (b) determining a desired fluid flow rate at the fluid outlet, and (c) adjusting a pressure of the flow chamber such that the deflectable membrane changes a fluidic resistance of the flow chamber to achieve the desired flow rate at the fluid outlet.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A is a perspective view of a flow modulator, according to an example embodiment.

FIGS. 1B-1D are cross-sectional side views of the flow modulator of FIG. 1A under different membrane deflection states, according to example embodiments.

FIG. 2A is a perspective view of a two-way valve, according to an example embodiment.

FIG. 2B-2D are cross-sectional side views of the two-way valve of FIG. 2A under different membrane deflection states, according to example embodiments.

FIG. 3A is a perspective view of a check valve, according to an example embodiment.

FIG. 3B is a top view of the check valve of FIG. 3A, according to an example embodiment.

FIG. 3C-3E are cross-sectional side views of the check valve of FIG. 3A under different membrane deflection states, according to example embodiments.

FIG. 4A is a perspective view of a peristaltic pump, according to an example embodiment.

FIG. 4B is a cross-sectional side view of the peristaltic pump of FIG. 4A, according to an example embodiment.

FIG. 4C is a schematic illustration of the valve states of the peristaltic pump of FIG. 4A in the six-phase actuation sequence, according to an example embodiment.

FIG. 4D is a waveform of the valve states of the peristaltic pump of FIG. 4A in the six-phase actuation sequence, according to an example embodiment.

FIG. 5A is a perspective view of a check valve pump, according to an example embodiment.

FIG. 5B is a cross-sectional side view of the check valve pump of FIG. 5A, according to an example embodiment.

FIG. 6A is a perspective view of a diffuser/nozzle pump, according to an example embodiment.

FIG. 6B is a cross-sectional side view of the diffuser/nozzle pump of FIG. 6A, according to an example embodiment.

FIG. 7A is a perspective view the fluidic control device, according to an example embodiment.

FIG. 7B is a top view of the fluidic control device of FIG. 7A, according to an example embodiment.

FIG. 7C is a cross-sectional side view of the fluidic control device of FIG. 7A, according to an example embodiment.

FIG. 7D is a perspective view of the fluidic control device of FIG. 7A with external connectors attached, according to an example embodiment.

FIG. 7E is a perspective view of another embodiment of a fluidic control device, according to an example embodiment.

FIG. 8 is a perspective view of another embodiment of a fluidic control device, according to an example embodiment.

FIG. 9 is a perspective view of yet another embodiment of a fluidic control device, according to an example embodiment.

FIG. 10 is a flowchart illustrating an example method according to an example embodiment.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

As used herein, with respect to measurements, “about” means+/−5%.

As used herein, “longitudinal axis” is an axis along the lengthwise direction of a given component, passing through the center of the component.

The present disclosure provides an assembly-free fabrication method and various fluidic control devices which allow for the fabrication of hydraulically- or pneumatically-actuated valves and pumps using a single additive-manufacturing/3D-printing process with one or more materials. Alternative membrane valve fabrication techniques require two or more separate layers, at least one of which is an elastomeric material, to be aligned and bonded together irreversibly, which requires significant training for the engineer fabricating the valve and suffers from poor reproducibility. The method of manufacture described herein utilizes an additive-manufacturing technique capable of creating void structures (e.g., stereolithography, multi jet modeling, inkjet printing, selective laser sintering/melting, and fused deposition modeling) to build a thin deflectable membrane within a fluidic control device concurrently with the other device features. Thus, no alignment or bonding step is required.

The present disclosure makes use of thin, deflectable membranes which may be non-elastic (Young's Modulus >>3 MPa), with deflectable membrane areas large enough to produce significant deflection for the purpose of modulating fluid movement within fluidic channels. Multi-material additive-manufacturing techniques may be used to create the thin deflectable membranes in a material with lower Young's Modulus compared to the other device components while remaining within a single manufacturing process and without need for assembly.

In certain embodiments, the general concept is that larger deflectable membrane radii/diameters and control pressures allow for greater deflection, while larger membrane thicknesses allow for less deflection. The thickness of the deflectable membrane may be limited by orienting the deflectable membrane perpendicular to the build stage (such that the deflectable membrane is formed as a series of stacked layers defined by the thickness of the laser beam or projected pixels of the additive-manufacturing process).

An applicable equation for the amount of membrane deflection is:

$$\frac{{Pr}^{4}}{{Et}^{4}} = \frac{5.33}{1 - {v}^{2}} \cdot \frac{y}{t} + \frac{2.6}{1 - {v}^{2}} \cdot {( \frac{y}{t} )}^{3}$$

where y=vertical deflection at center of the deflectable membrane, P=control pressure, r=radius of the deflectable membrane, E=Young's modulus, t=thickness of the deflectable membrane, and v=Poisson's ratio.

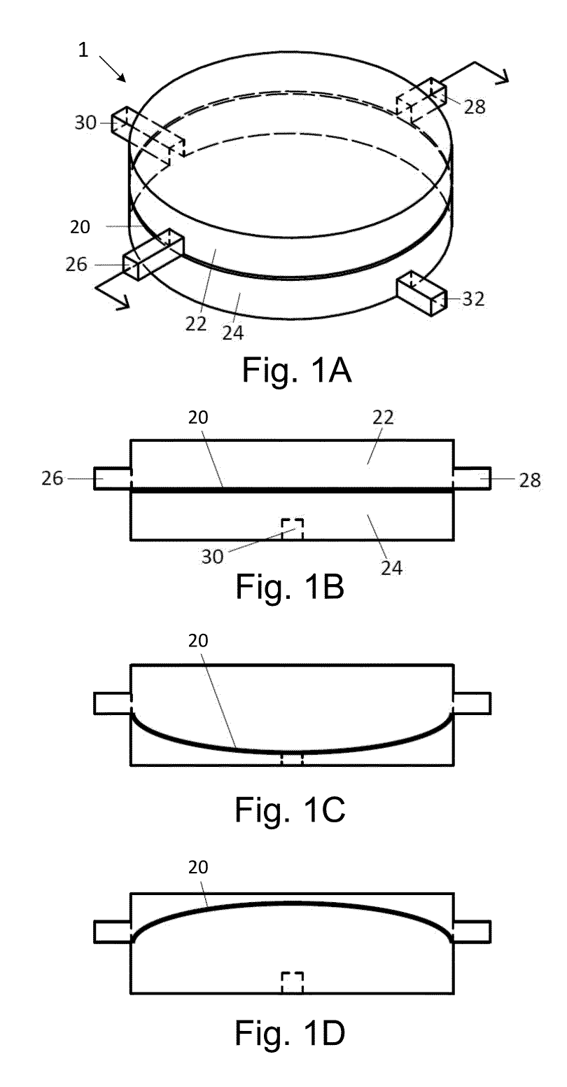

With reference to the Figures, FIGS. 1A-1D illustrate a flow modulator 1 according to an example embodiment. As seen in FIG. 1A, the flow modulator 1 contains a thin deflectable membrane 20, which separates a flow chamber 22 from a control chamber 24, which can be actuated pneumatically or hydraulically. Fluid flow enters the flow chamber 22 from a fluid inlet 26, and exits the flow chamber 22 from a fluid outlet 28. Pressure inputs reach the control chamber 24 from the control channel 30. A control chamber rinse channel 32 may be used to facilitate the removal of un-cured resin or un-crosslinked powder from the control chamber 24 where necessitated by the additive-manufacturing technique used. During operation of the fluidic control element, the outlet of the control chamber rinse channel 32 is sealed reversibly or irreversibly with adhesive tape, glue, or a plastic connector matching the geometry of the outlet port (not shown). The flow modulator 1 may further include a substrate bonded to a bottom surface of the flow chamber 22 such that the deflectable membrane 20 is substantially parallel to the substrate.

FIGS. 1B-1D are cross-sectional side views of the flow modulator 1 under different membrane deflection states. FIG. 1B shows deflectable membrane 20 in its undeflected state, which occurs when no pressure is applied to the flow chamber 22 or control chamber 24, or when equal pressure is applied to the deflectable membrane 20 from the flow chamber 22 and control chamber 24. FIG. 1C shows deflectable membrane 20 in a downward deflected state, which occurs when greater pressure is applied to the deflectable membrane 20 from the flow chamber 22 than from the control chamber 24. In this state, the flow resistance through the flow modulator is reduced compared to in the undeflected state; thus, the volumetric flow rate through the flow modulator is greater in this state compared to in the undeflected state, assuming the fluids are driven under equal driving pressures. FIG. 1D shows deflectable membrane 20 in an upward deflected state, which occurs when greater pressure is applied to the deflectable membrane 20 from the control chamber 24 than from the flow chamber 22. In this state, the flow resistance through the flow modulator 1 is increased compared to in the undeflected and downward deflected states; thus, the volumetric flow rate through the flow modulator 1 is less in this state compared to in the undeflected or downward deflected states, assuming the fluids are driven under equal driving pressures.

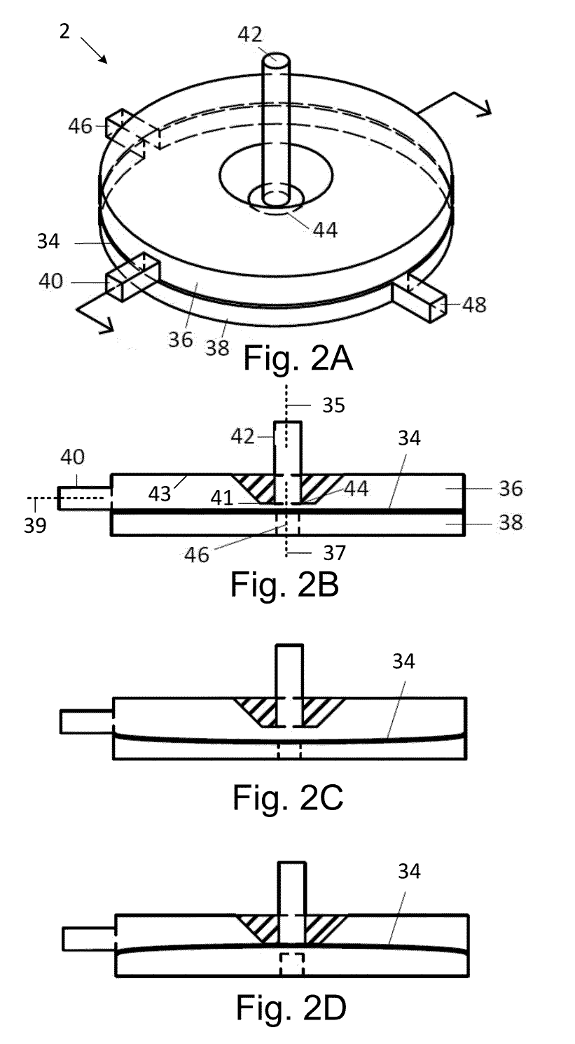

FIGS. 2A-2D illustrate a two-way valve 2 according to an example embodiment. As seen in FIG. 2A, the two-way valve 2 contains a thin deflectable membrane 34, which separates a flow chamber 36 from a control chamber 38, which can be actuated pneumatically or hydraulically. Fluid flow enters the flow chamber 36 from a fluid inlet 40, and exits the flow chamber 36 from a fluid outlet 42. As shown in FIG. 2B, the longitudinal axis of the fluid outlet 35 aligns with the longitudinal axis of the deflectable membrane 37. The longitudinal axis of the deflectable membrane 37 is substantially orthogonal to a line defining a diameter of the deflectable membrane 34. In addition, the longitudinal axis of the fluid outlet 35 is substantially orthogonal to the longitudinal axis of the fluid inlet 39. Pressure inputs reach the control chamber from the control channel 46. A control chamber rinse channel 48 may be used to facilitate the removal of un-cured resin or un-crosslinked powder from the control chamber 38 where necessitated by the additive-manufacturing technique used. During operation of the fluidic control element, the outlet of the control chamber rinse channel 48 is sealed reversibly or irreversibly with adhesive tape, glue, or a plastic connector matching the geometry of the outlet port (not shown). The two-way valve 2 may further include a substrate bonded to a bottom surface of the flow chamber 36 such that the deflectable membrane 34 is substantially parallel to the substrate.

Further, as shown in FIG. 2A, the fluid outlet 42 is located beyond a conical aperture 44 centered within the flow chamber 36. In particular, the flow chamber 36 may include a first interior surface 41 positioned substantially parallel to a second interior surface 43, which may both be positioned substantially parallel to the deflectable membrane 34. The first interior surface 41 may be positioned closer to the deflectable membrane 34 than the second interior surface 43. As such, the first interior surface 41 and second interior surface 43 may create a conical structure protruding from the second interior surface 43 towards the deflectable membrane 34. An aperture 44 may be positioned on the first interior surface 41.

FIGS. 2B-2D are cross-sectional side views of the two-way valve 2 under different membrane deflection states. FIG. 2B shows deflectable membrane 34 in its undeflected state, which occurs when no pressure is applied to the flow chamber 36 or control chamber 38, or when equal pressure is applied to the deflectable membrane 34 from the flow chamber 36 and control chamber 38. FIG. 2C shows deflectable membrane 34 in a downward deflected state, which occurs when greater pressure is applied to the deflectable membrane 34 from the flow chamber 36 than from the control chamber 38. In this state, the flow resistance through the flow modulator is reduced compared to in the undeflected state; thus, the volumetric flow rate through the flow modulator is greater in this state compared to in the undeflected state, assuming the fluids are driven under equal driving pressures. FIG. 2D shows deflectable membrane 34 in an upward deflected state, which occurs when greater pressure is applied to the deflectable membrane 34 from the control chamber 38 than from the flow chamber 36. In this state, due to the small distance between the deflectable membrane 34 and the conical aperture 44, under reasonable control chamber pressures, the deflectable membrane 34 seals off the conical aperture 44 fully, preventing fluid from reaching the fluid outlet 42. Thus, the two-way valve 2 is closed to fluid flow in this state.

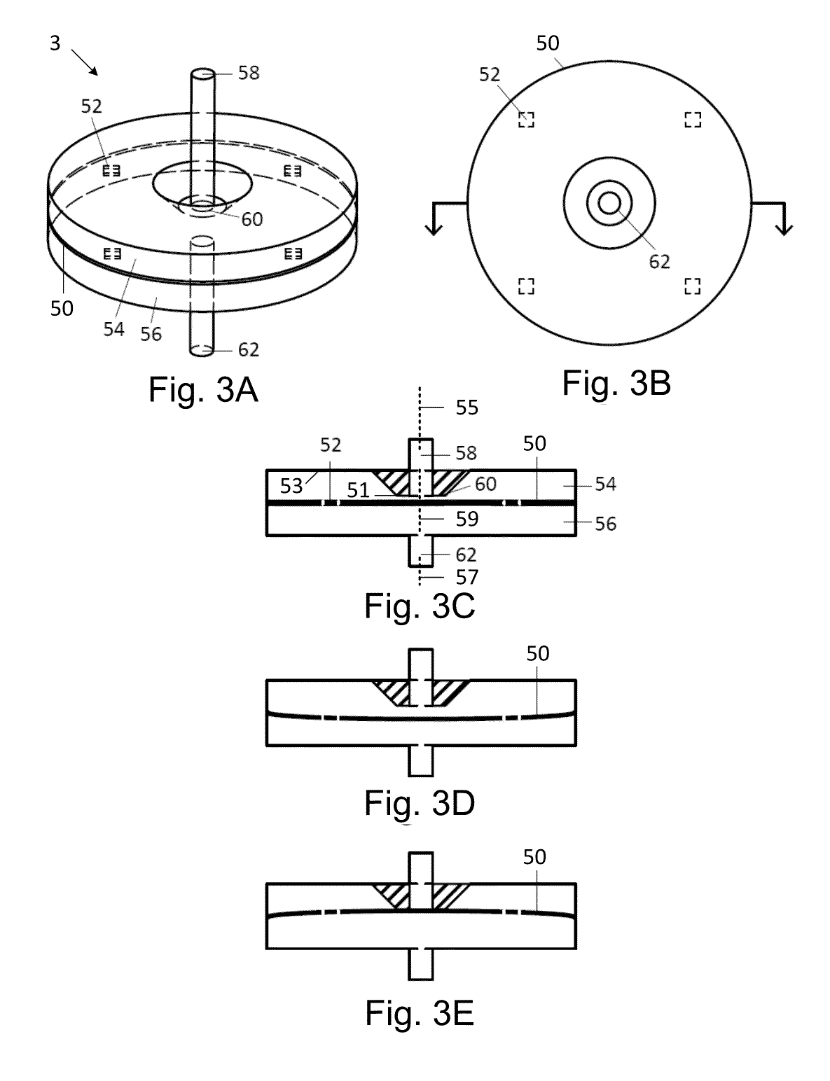

FIGS. 3A-3E illustrate a check valve 3 according to an example embodiment. As seen in FIG. 3A, the check valve 3 contains a thin deflectable membrane 50 with perforations 52, which separates a first flow chamber 54 from a second flow chamber 56. Fluid flow enters the first flow chamber 54 from a fluid inlet 58, and passes through a conical aperture 60 and the perforated deflectable membrane 50 into the second flow chamber 56. As shown in FIG. 3C, the longitudinal axis of the fluid inlet 55 and the longitudinal axis of the fluid outlet 57 align with the longitudinal axis of the deflectable membrane 59. The fluid flow exits the second flow chamber 56 from a fluid outlet 62 on the opposite side of the perforated membrane 50 from the aperture 60. As seen in FIG. 3B, the total area of the perforations in the deflectable membrane 50 is small relative to the total surface area of the deflectable membrane 50.

Further, as shown in FIG. 3A, the fluid outlet 62 is located beyond a conical aperture 60 centered within the first flow chamber 54. In particular, the first flow chamber 54 may include a first interior surface 51 positioned substantially parallel to a second interior surface 53, which may both be positioned substantially parallel to the deflectable membrane 50. The first interior surface 51 may be positioned closer to the deflectable membrane 50 than the second interior surface 53. As such, the first interior surface 51 and second interior surface 53 may create a conical structure protruding from the second interior surface 53 towards the deflectable membrane 50. An aperture 60 may be positioned on the first interior surface 51.

FIGS. 3C-3E are cross-sectional side views of the check valve 3 under different membrane deflection states. FIG. 3C shows membrane 50 in its undeflected state, which occurs when there is no fluid flow through the flow chambers and thus there is no pressure is applied to the deflectable membrane 50. FIG. 3D shows membrane 50 in a downward deflected state, which occurs when there is fluid flow in the intended direction from the fluid inlet 58 to the fluid outlet 62. In this state, the fluid is able to pass through the perforations 52 in the deflectable membrane 50 and reach the fluid outlet 62. FIG. 3E shows membrane 50 in an upward deflected state, which occurs when there is fluid flow opposite the intended direction. In this state, due to the small distance between the deflectable membrane 50 and the conical aperture 60, under reasonable flow rates, the deflectable membrane 50 seals off the conical aperture 60 fully, preventing fluid from passing through the aperture 60 and reaching the fluid inlet 58. Thus, the check valve 3 is closed to fluid backflow in this state.

Each of the fluidic control devices described in FIGS. 1A-3E may represent modules that act as building blocks for more sophisticated fluidic control devices with amplified functionality. As such, the devices 1, 2, & 3 described above may be stored as a digital file representing the structure of the device that can be manufactured using an additive-manufacturing technique, such as stereolithography. In each such digital file, the deflectable membrane for each module is oriented perpendicular to the build stage (such that the deflectable membrane is formed as a series of stacked layers defined by the thickness of the laser beam or projected pixels of the additive-manufacturing process). A user may then combine a plurality of such modules to create a more complicated fluidic control device, and subsequently manufacture the combined fluidic control device using an additive manufacturing system.

As such, each of the devices 1, 2, & 3 may represent a module, a segment, or a portion of program code, which includes one or more instructions executable by a processor or computing device for creating such devices using an additive manufacturing system. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

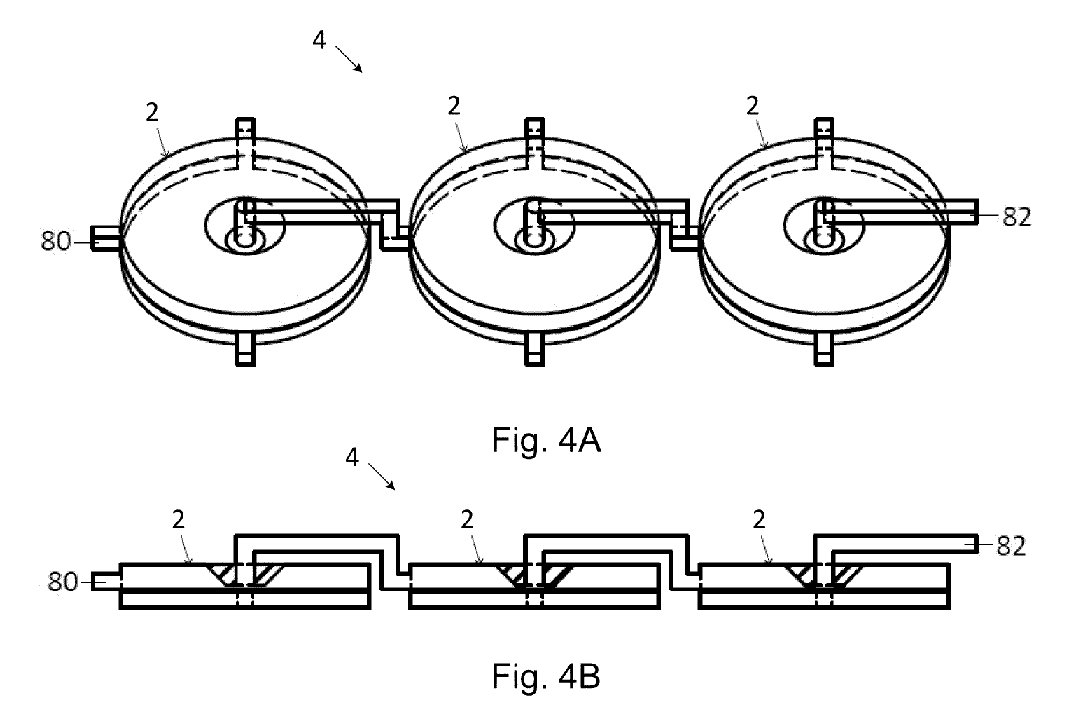

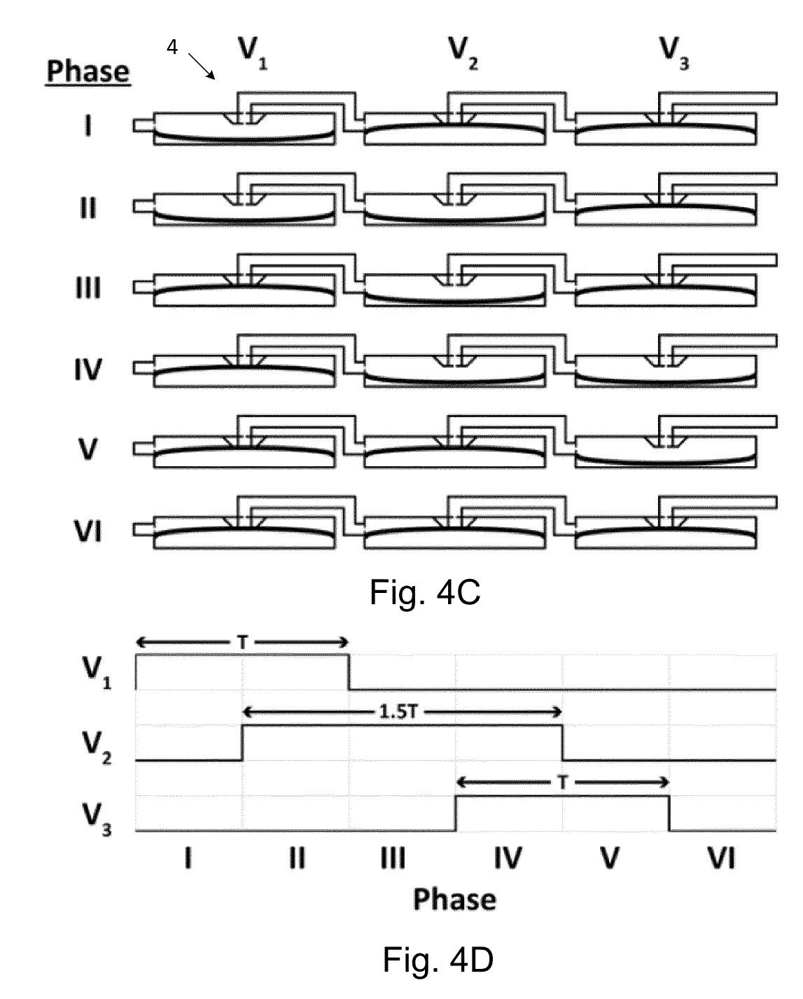

FIGS. 4A-4B illustrate a peristaltic pump 4 formed by placing three two-way valves 3 in series with one another. Fluid flow enters the pump through a fluid inlet 80 and passes through each of the valves before exiting through a fluid outlet 82. Fluid flow can be driven from the inlet to the outlet in the absence of external pressure applied directly to the fluid inlet by sequentially closing the valves, starting with the valve closest to the fluid inlet and moving in the direction of the fluid outlet.

FIG. 4C illustrates the peristaltic pump 4 of FIG. 4A in various states of an activation sequence. By opening and closing the three two-way valves 3 in the order shown in FIG. 4C, fluid can be driven from the fluid inlet 80 to the fluid outlet 82. FIG. 4D illustrates a waveform of the valve states of the peristaltic pump 4 of FIG. 4A in the six-phase actuation sequence, with valves V₁ and V₃ open for time T.

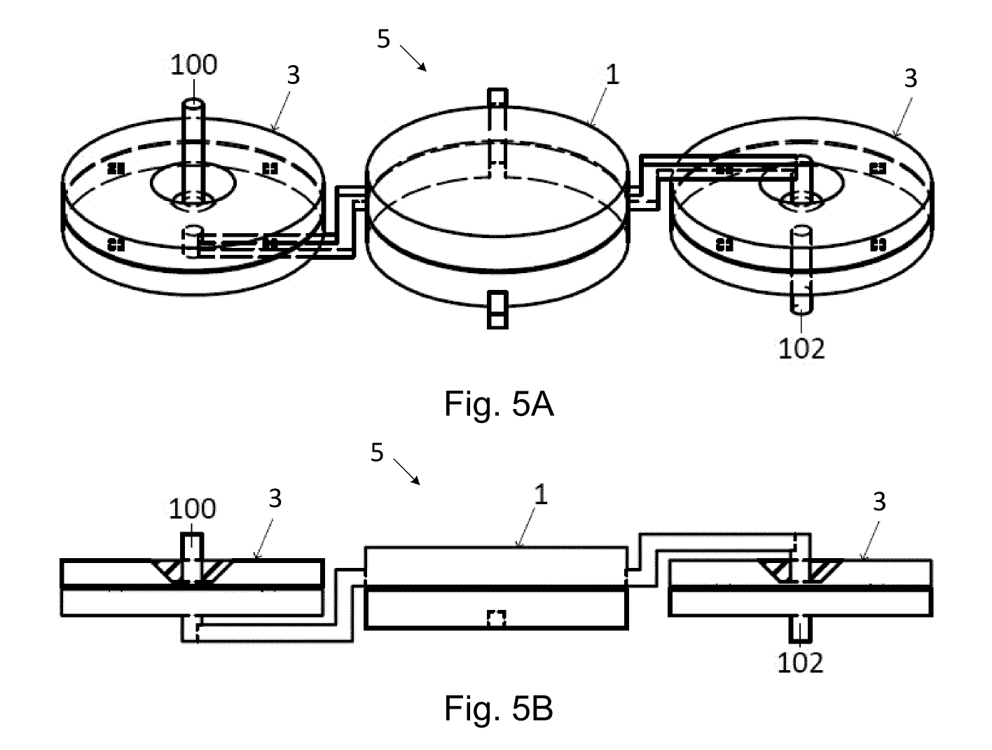

FIGS. 5A-5B illustrate a check valve pump 5 formed by placing check valves 3 on either side of a flow modulator 1. Fluid flow enters the check valve pump 5 through a fluid inlet 100 and passes through the first check valve, flow modulator, and second check valve before exiting through a fluid outlet 102. Fluid flow can be driven from the inlet 100 to the outlet 102 in the absence of external pressure applied directly to the fluid inlet by deflecting the membrane of the flow modulator upwards and downwards. When the membrane of the flow modulator is deflected upwards towards the flow chamber, the volume of fluid displaced by the membrane is pushed out from the flow modulator. Due to the check valve placed upstream of the flow modulator, fluid cannot flow from the flow modulator to the fluid inlet and must instead flow through the downstream check valve to the fluid outlet. When the membrane of the flow modulator is deflected downwards towards the control chamber, fluid is drawn into the flow modulator to replace the volume previously occupied by the membrane. Due to the check valve placed downstream of the flow modulator, fluid cannot flow from the fluid outlet 102 to the flow modulator and must instead flow from the fluid inlet 100 and through the upstream check valve to the flow modulator.

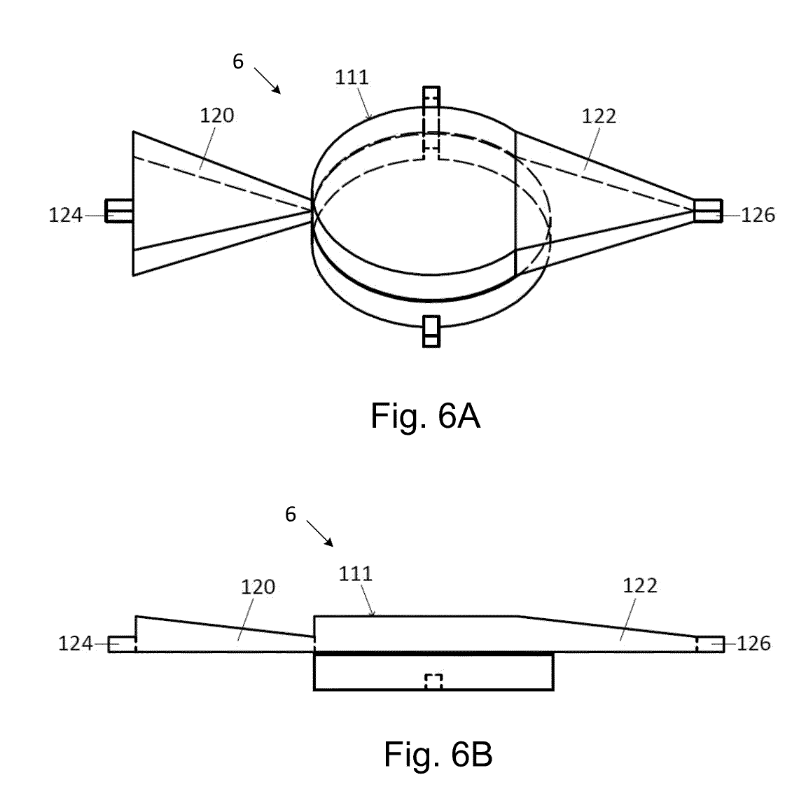

FIGS. 6A-6B illustrate a diffuser/nozzle valve formed by placing an upstream diffuser/nozzle 120 in series with a modified flow modulator 111 and a downstream diffuser/nozzle 122. Fluid flow enters the diffuser/nozzle valve 6 through a fluid inlet 124 connected to the upstream diffuser/nozzle and exits through a fluid outlet 126 connected to the downstream diffuser/nozzle. Fluid flow can be driven from the inlet to the outlet in the absence of external pressure applied directly to the fluid inlet by deflecting the membrane of the flow modulator upwards and downwards. When the membrane of the flow modulator is deflected upwards towards the flow chamber, the volume of fluid displaced by the membrane is pushed out from the flow modulator. Due to the upstream diffuser/nozzle acting as a diffuser and the downstream diffuser/nozzle acting as a nozzle in this situation, the majority of the fluid preferentially moves through the downstream nozzle towards the outlet. When the membrane of the flow modulator is deflected downwards towards the control chamber, fluid is drawn into the flow modulator to replace the volume previously occupied by the membrane. Due to the upstream diffuser/nozzle acting as a nozzle and the downstream diffuser/nozzle acting as a diffuser in this situation, the majority of the fluid preferentially enters the flow modulator through the upstream nozzle from the inlet.

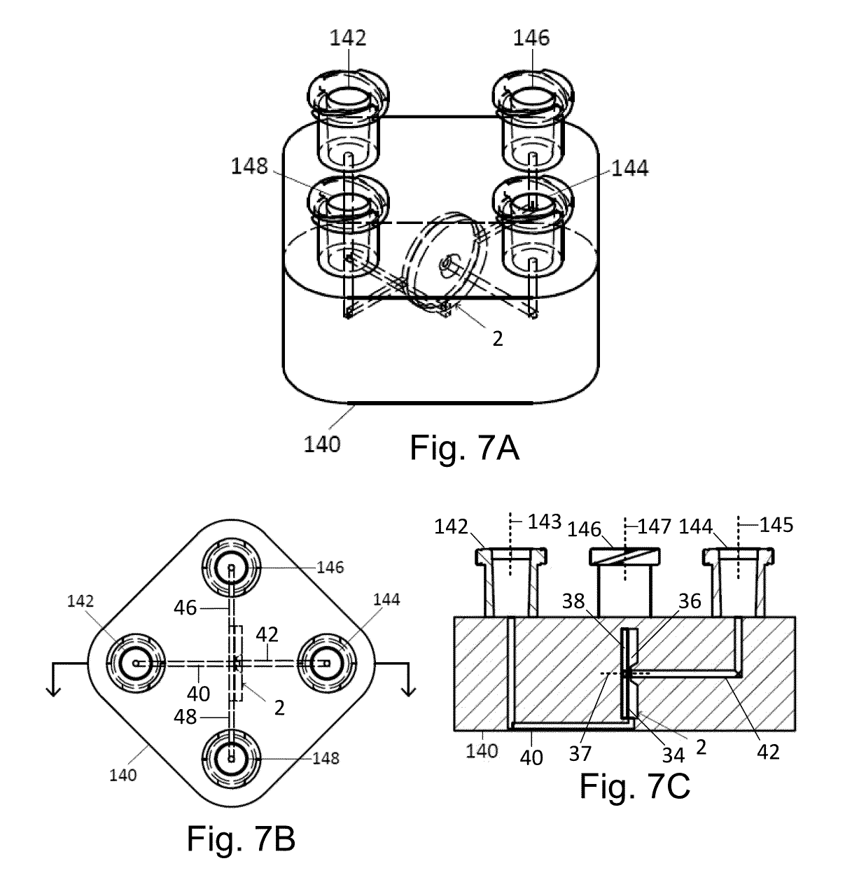

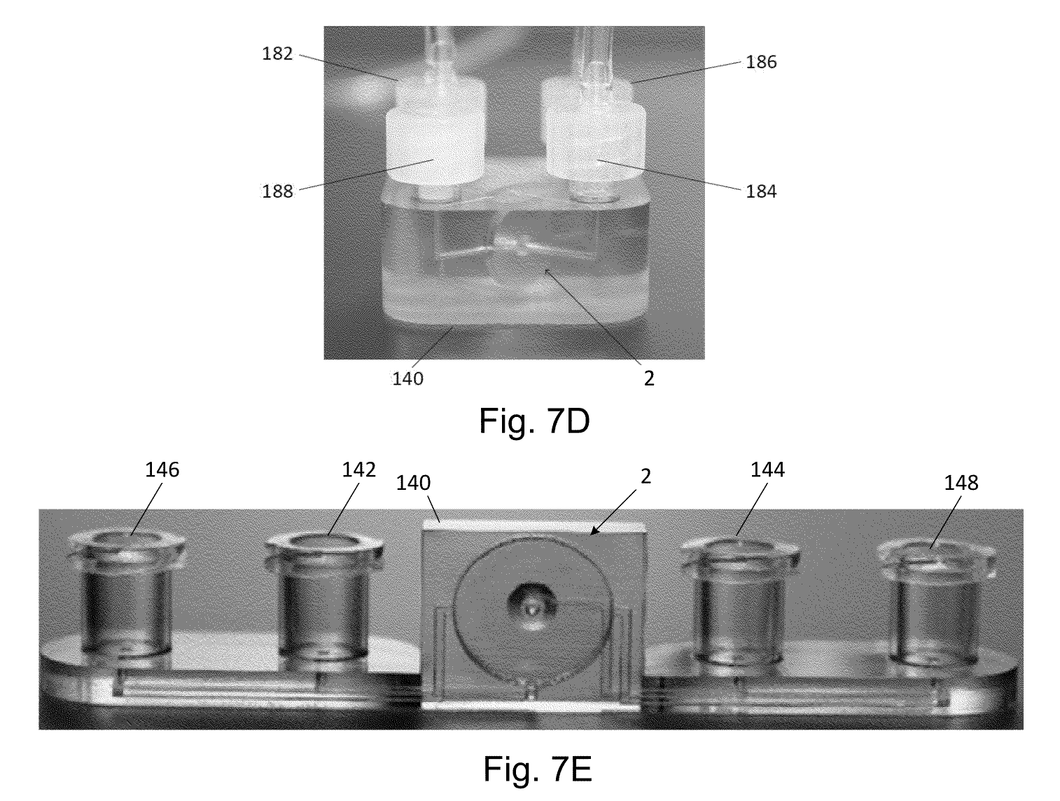

FIGS. 7A-7E illustrate an embodiment of a fluidic control device integrating a two-way valve 3 within an outer device housing 140. As shown in FIG. 7C, the housing 140 surrounds the flow chamber 36, the control chamber 38, the fluid inlet 40, the fluid outlet 42, the deflectable membrane 34, and the control channel 46. The fluidic control device may further include a fluid inlet port 142 in fluid communication with the fluid inlet 40. As shown in FIG. 7C, the longitudinal axis of the fluid inlet port 143 is substantially orthogonal to the longitudinal axis of the deflectable membrane 37. The fluidic control device may further include a fluid outlet port 144 in fluid communication with the fluid outlet 42. As shown in FIG. 7C, the longitudinal axis of the fluid outlet port 145 is substantially orthogonal to the longitudinal axis of the deflectable membrane 37. Further, the fluidic control device may include a control input port 146 in fluid communication with the control channel 46. As shown in FIG. 7C, the longitudinal axis of the control input port 147 is substantially orthogonal to the longitudinal axis of the deflectable membrane 37.

As discussed above, a control chamber rinse channel 48 may be used to facilitate the removal of un-cured resin or un-crosslinked powder from the control chamber 38 where necessitated by the additive-manufacturing technique used. In such an example, the fluidic control device may further include a control chamber rinse channel port 148 in fluid communication with the control chamber rinse channel 48. The longitudinal axis of the control chamber rinse channel port is substantially orthogonal to the longitudinal axis of the deflectable membrane 37. As shown in FIG. 7A, each of the fluid inlet port 142, fluid outlet port 144, control input port 146, and control chamber rinse channel port 148 may be positioned on a top surface of the housing 140.

In one example, each of the fluid inlet port 142, fluid outlet port 144, control input port 146, and control chamber rinse channel port 148 may include a female luer connector including threads. The female luer connectors may be built directly into each of the fluid inlet port 142, fluid outlet port 144, control input port 146, and control chamber rinse channel port 148 during a build stage of the fluidic control device. As seen in FIG. 7D, in order to operate the fluidic control device, barbed luer connectors can be connected via the female luer connectors to the fluidic control device to interface a fluid input line 182, a fluid output line 184, and a control line 186. The control chamber rinse channel port 148, which is only necessary to facilitate the removal of un-cured resin from the control chamber of the device during fabrication, is covered with a luer plug 188, to seal off the control chamber from the outside environment. Syringes with luer connectors can be connected to the fluid inlet port 142 and fluid outlet port 144 instead of the barbed luer connectors to create device-integrated fluid reservoirs (not shown). Alternative embodiments of a valving device may use hose barb connectors built directly into the device in order to directly interface with external tubing. Other example connections are possible as well.

As discussed above in relation to FIGS. 2B-2D, the deflectable membrane 34 can be deflected by altering the pressure applied to the control chamber 36 to achieve various flow through the fluidic control device. For example, the deflectable membrane 34 is in its undeflected state when no pressure is applied to the flow chamber 36 or control chamber 38, or when equal pressure is applied to the deflectable membrane 34 from the flow chamber 36 and control chamber 38. In another example, deflectable membrane 34 may be in a downward deflected state when greater pressure is applied to the deflectable membrane 34 from the flow chamber 36 than from the control chamber 38. In this state, the flow resistance through the flow modulator is reduced compared to in the undeflected state; thus, the volumetric flow rate through the fluidic control device is greater in this state compared to in the undeflected state, assuming the fluids are driven under equal driving pressures. Finally, deflectable membrane 34 may be in an upward deflected state when greater pressure is applied to the deflectable membrane 34 from the control chamber 38 than from the flow chamber 36. In this state, due to the small distance between the deflectable membrane 34 and the conical aperture 44, under reasonable control chamber pressures, the deflectable membrane 34 seals off the conical aperture 44 fully, preventing fluid from reaching the fluid outlet 42. Thus, the fluidic control device is closed to fluid flow in this state.

FIG. 7E illustrates an alternative embodiment of the fluidic control device of FIGS. 7A-7D. Similar to the embodiment described above, FIG. 7E illustrates a fluidic control device integrating a two-way valve 3 within an outer device housing 140. As shown in FIG. 7E, the housing 140 surrounds the flow chamber 36, the control chamber 38, the fluid inlet 40, the fluid outlet 42, the deflectable membrane 34, and the control channel 46. The fluidic control device of FIG. 7E also includes a fluid inlet port 142, a fluid outlet port 144, a control input port 146, and optionally a control chamber rinse channel port 148. As shown in FIG. 7E, the longitudinal axis of each of the fluid inlet port 142, fluid outlet port 144, control input port 146, and control chamber rinse channel port 148 are substantially orthogonal to the longitudinal axis of the deflectable membrane 37.

Although FIGS. 7A-7E illustrate a fluidic control device incorporating a two-way valve 3 within the housing 140, other embodiments are possible as well. For example, another fluidic control device may include a flow modulator 1 within an outer device housing 140. The housing 140 may surround the first flow chamber 54, the second flow chamber 56, the fluid inlet 58, the deflectable membrane 50 and the fluid outlet 62. Such a fluidic control device may also include a fluid inlet port, a fluid outlet port, a control input port, and optionally a control chamber rinse channel port, as discussed above. The longitudinal axis of each of the fluid inlet port, fluid outlet port, control input port, and control chamber rinse channel port are substantially orthogonal to the longitudinal axis of the deflectable membrane 20.

In yet another embodiment, an example fluidic control device may include a check valve 3 within an outer device housing 140 suitable for fabrication using stereolithography. In such an embodiment, the housing 140 may surround the flow chamber 22, the control chamber 24, the fluid inlet 26, the fluid outlet 28, the deflectable membrane 20, and the control channel 30. Such a fluidic control device may also include a fluid inlet port, a fluid outlet port, a control input port, and optionally a control chamber rinse channel port, as discussed above. The longitudinal axis of each of the fluid inlet port, fluid outlet port, control input port, and control chamber rinse channel port are substantially orthogonal to the longitudinal axis of the deflectable membrane 50.

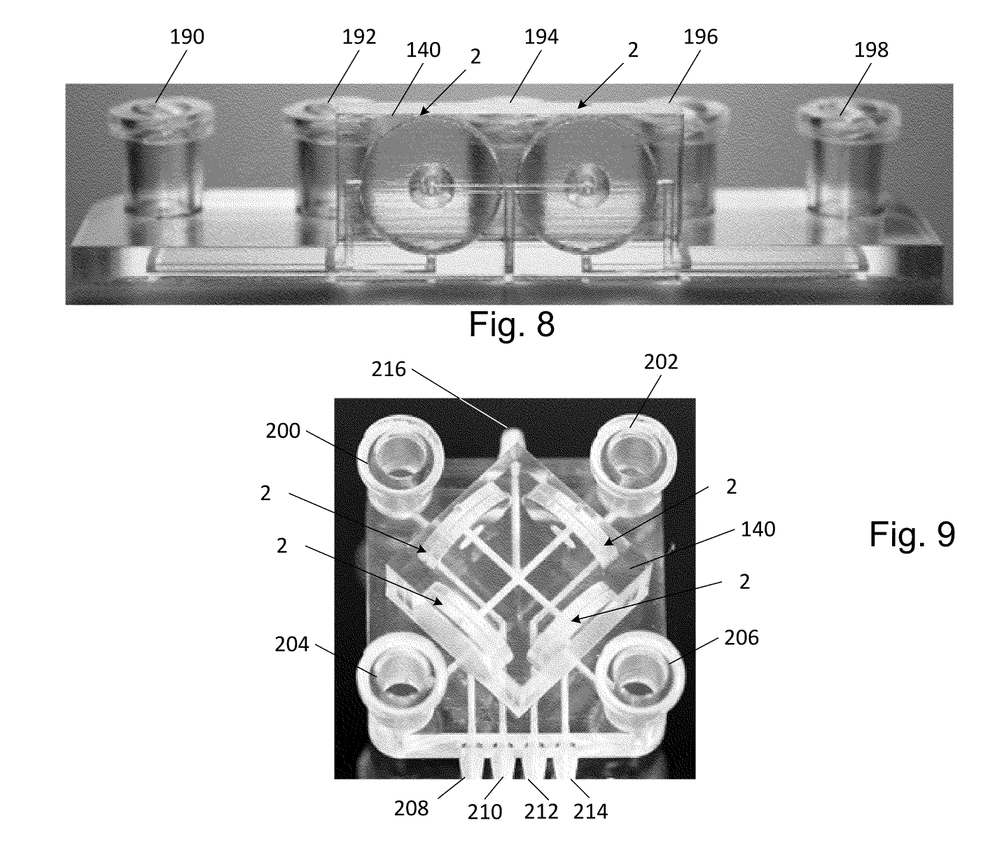

FIG. 8 is a perspective view of another embodiment of a fluidic control device, according to an example embodiment. As shown in FIG. 8, the fluidic control device includes two two-way valves 2 within an outer device housing 140. The fluidic control device further includes a first control input port 190, a first fluid inlet port 192, a fluid outlet port 194, a second fluid inlet port 196, and a second control input port 198. The longitudinal axis of each of the first control input port 190, the first fluid inlet port 192, the fluid outlet port 194, the second fluid inlet port 196, and the second control input port 198 are substantially orthogonal to the longitudinal axis of the deflectable membrane of each of the two-way valves 2. In operation, pressure from the first control input port 190 may be altered to control fluid flow from the first fluid inlet port 192 to the fluid outlet port 194, through the first two-way valve 2. Similarly, pressure from the second control input port 198 may be altered to control fluid flow from the second fluid inlet port 196 to the fluid outlet port 194, through the second two-way valve 2. Thus, the fluidic control device is configured to allow fluid flow from both the first fluid inlet port 192 and the second fluid inlet port 196 to the fluid outlet port 194, prevent fluid flow from both the first fluid inlet port 192 and the second fluid inlet port 196 to the fluid outlet port 194, or allow fluid flow from one of the first fluid inlet port 192 or the second fluid inlet port 196 to the fluid outlet port 194.

FIG. 9 is a perspective view of yet another embodiment of a fluidic control device, according to an example embodiment. As shown in FIG. 9, the fluidic control device includes four two-way valves 2 within an outer device housing 140. The fluidic control device further includes a first fluid inlet port 200, a second fluid inlet port 202, a third fluid inlet port 204, a fourth fluid inlet port 206, a first control input port 208, a second control input port 210, a third control input port 212, a fourth control input port 214, and a fluid outlet port 216. In operation, pressure from the first control input port 208 may be altered to control fluid flow from the first fluid inlet port 200 to the fluid outlet port 216, through the first two-way valve 2. Pressure from the second control input port 210 may be altered to control fluid flow from the second fluid inlet port 202 to the fluid outlet port 216, through the second two-way valve 2. Pressure from the third control input port 212 may be altered to control fluid flow from the second fluid inlet port 204 to the fluid outlet port 216, through the third two-way valve 2. Finally, pressure from the fourth control input port 214 may be altered to control fluid flow from the fourth fluid inlet port 208 to the fluid outlet port 216, through the fourth two-way valve 2. As such, any combination of fluids from each of the four fluid inlet ports may be combined at the fluid outlet port.

In certain embodiments, such as shown in any one of FIGS. 7A-9, example fluidic control devices may be made using an additive-manufacturing process such that the deflectable membrane is built concurrently with each of the other components of the fluidic control device. In one example, the additive-manufacturing process is a multi-material additive-manufacturing process such that the deflectable membrane is created using a material with a greater elasticity than the other components of the fluidic control device. In one particular example, the additive-manufacturing process is stereolithography. Using stereolithography, each deflectable membrane of a particular fluidic control device can be created with thickness equivalent to the beam diameter of the curing laser used by building the membrane orthogonal to the direction of the build stage, such that laser over-curing in the z-direction does not add to the final thickness of the membrane produced. Thus, in one example, the deflectable membrane thickness may be about 100 micrometers (based on the laser beam diameter). In further examples, the deflectable membrane diameter may be about 10 millimeters, the spacing between the membrane and the aperture may be about 250 micrometers, and the diameter of the aperture opening may be about 750 micrometers. In such an embodiment, a control pressure of 7.5 psi may fully close an example valve against a fluid driving pressure of 5 psi. That is, the membrane diameter-to-thickness ratio may be 100:1, though other ratios, including those greater, are also contemplated herein as well. Similarly, a ratio of the membrane thickness to aperture gap distance may be 2:5, though other ratios are considered herein as well. Also, a ratio of the membrane diameter to aperture gap distance may be 40:1, though other ratios, including those greater, are also considered. As will be appreciated by those of ordinary skill in the art, other ratios and relative dimensions may also be employed without departing from the spirit of the invention, including through the use of different materials for the integrally-formed membrane of the fluidic device.

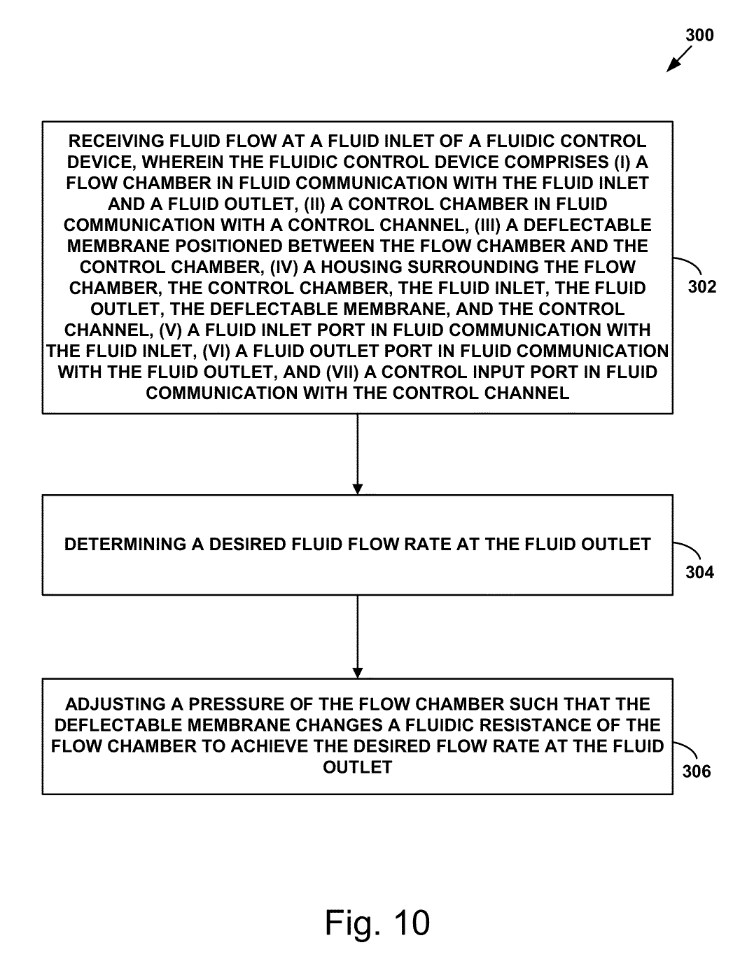

FIG. 10 is a block diagram of an example method for adjusting a fluid flow rate through a fluidic control device. Method 300 shown in FIG. 10 presents an embodiment of a method that could be used by the flow modulator 1 of FIGS. 1A-1D, or the two-way valve 2 of FIGS. 2A-2D, as examples. Method 300 may include one or more operations, functions, or actions as illustrated by one or more of blocks 302-306. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 300 and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

In addition, for the method 300 and other processes and methods disclosed herein, each block in FIG. 3 may represent circuitry that is wired to perform the specific logical functions in the process.

Initially, at block 302, the method 300 includes receiving fluid flow at a fluid inlet of a fluidic control device. The fluidic control device may include (i) a flow chamber in fluid communication with the fluid inlet and a fluid outlet, (ii) a control chamber in fluid communication with a control channel, (iii) a deflectable membrane positioned between the flow chamber and the control chamber, (iv) a housing surrounding the flow chamber, the control chamber, the fluid inlet, the fluid outlet, the deflectable membrane, and the control channel, (v) a fluid inlet port in fluid communication with the fluid inlet, (vi) a fluid outlet port in fluid communication with the fluid outlet, and (vii) a control input port in fluid communication with the control channel.

At block 304, the method 300 includes determining a desired flow rate at the fluid outlet. In one example, the desired flow rate may be received via a user interface. In another example, the desired flow rate may be pre-programmed into a control system of the fluidic control device. Other examples are possible as well. Next, at block 306, the method 300 includes adjusting a pressure of the flow chamber such that the deflectable membrane changes a fluidic resistance of the flow chamber to achieve the desired flow rate at the fluid outlet. In one example, the desired fluid flow rate at the fluid outlet is zero cubic meters per second. In such an example, the fluidic control device may apply enough pressure to the control chamber to cause the deflectable membrane to completely close off fluid flow through the fluid outlet.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense. Further, it is intended to be understood that the following clauses (and any combination of the clauses) further describe aspects of the present description.

We claim:

1. A fluidic control device, comprising:
a flow chamber in fluid communication with a fluid inlet and a fluid outlet;
a control chamber in fluid communication with a control channel;
a deflectable membrane positioned between the flow chamber and the control chamber;
a housing surrounding the flow chamber, the control chamber, the fluid inlet, the fluid outlet, the deflectable membrane, and the control channel;
a fluid inlet port in fluid communication with the fluid inlet, wherein a longitudinal axis of the fluid inlet port is substantially orthogonal to a longitudinal axis of the deflectable membrane, and wherein the longitudinal axis of the deflectable membrane is substantially orthogonal to a line defining a diameter of the deflectable membrane;
a fluid outlet port in fluid communication with the fluid outlet, wherein a longitudinal axis of the fluid outlet port is substantially orthogonal to the longitudinal axis of the deflectable membrane; and
a control input port in fluid communication with the control channel, wherein a longitudinal axis of the control input port is substantially orthogonal to the longitudinal axis of the deflectable membrane.

2. The fluidic control device of claim 1, wherein a longitudinal axis of the fluid outlet aligns with the longitudinal axis of the deflectable membrane.

3. The fluidic control device of claim 1, wherein a longitudinal axis of the fluid outlet is substantially orthogonal to a longitudinal axis of the fluid inlet.

4. The fluidic control device of claim 1, further comprising:
a substrate bonded to a bottom surface of the flow chamber such that the deflectable membrane is substantially parallel to the substrate.

5. The fluidic control device of claim 1, further comprising:
a control chamber rinse channel in fluid communication with the control chamber; and
a control chamber rinse channel port in fluid communication with the control chamber rinse channel, wherein a longitudinal axis of the control chamber rinse channel port is substantially orthogonal to the longitudinal axis of the deflectable membrane.

6. The fluidic control device of claim 1, wherein a ratio of the diameter of the deflectable membrane to a thickness of the deflectable membrane is about 100:1.

7. The fluidic control device of claim 1, wherein the flow chamber includes a first interior surface positioned substantially parallel to a second interior surface, wherein each of the first interior surface and the second interior surface are positioned substantially parallel to the deflectable membrane, and wherein the first interior surface is positioned closer to the deflectable membrane than the second interior surface, the fluidic control device further comprising:
an aperture positioned on the first interior surface of the flow chamber between the fluid outlet and the flow chamber.

8. The fluidic control device of claim 8, wherein a ratio of a thickness of the deflectable membrane to a distance between the deflectable membrane and the aperture is about 2:5.

9. The fluidic control device of claim 8, wherein a ratio of the diameter of a deflectable membrane to a distance between the deflectable membrane and the aperture is about 40:1.

10. The fluidic control device of claim 1, wherein the fluidic control device is created using an additive-manufacturing process such that the deflectable membrane is built concurrently with each of the other components of the fluidic control device.

11. The fluidic control device of claim 10, wherein the deflectable membrane has a thickness in a direction perpendicular from a build stage of the additive-manufacturing process.

12. The fluidic control device of claim 10, wherein the additive-manufacturing process is a multi-material additive-manufacturing process, and wherein the deflectable membrane is created using a material with a greater elasticity than the other components of the fluidic control device.

13. The fluidic control device of claim 1, wherein the fluidic control device comprises a first fluidic control device module, the fluidic control device further comprising:
(a) a second fluidic control device module including (i) a second flow chamber in fluid communication with a second fluid inlet and a second fluid outlet, (ii) a second control chamber, and (iii) a second deflectable membrane positioned between the second flow chamber and the second control chamber, wherein the fluid outlet is in fluid communication with the second fluid inlet; and
(b) a third fluidic control device module including (i) a third flow chamber in fluid communication with a third fluid inlet and a third fluid outlet, (ii) a third control chamber, and (iii) a third deflectable membrane positioned between the third flow chamber and the third control chamber, wherein the second fluid outlet is in fluid communication with the third fluid inlet.

14. A non-transitory computer readable medium having stored thereon instructions, that when executed by one or more processors, cause an additive manufacturing machine to create the fluidic control device of claim 1 such that the deflectable membrane is built concurrently with each of the other components of the fluidic control device.

15. A fluidic control device, comprising:
a first flow chamber in fluid communication with a fluid inlet, wherein the first flow chamber includes a first interior surface positioned substantially parallel to a second interior surface;
a second flow chamber in fluid communication with a fluid outlet;
a deflectable membrane positioned between the first flow chamber and the second flow chamber, wherein the deflectable membrane includes one or more perforations such that the first flow chamber is in fluid communication with the second flow chamber;
a housing surrounding the first flow chamber, the second flow chamber, the fluid inlet, the deflectable membrane, and the fluid outlet;
a fluid inlet port in fluid communication with the fluid inlet, wherein a longitudinal axis of the fluid inlet port is substantially orthogonal to a longitudinal axis of the deflectable membrane, and wherein the longitudinal axis of the deflectable membrane is substantially orthogonal to a line defining a diameter of the deflectable membrane; and
a fluid outlet port in fluid communication with the fluid outlet, wherein a longitudinal axis of the fluid outlet port is substantially orthogonal to the longitudinal axis of the deflectable membrane.

16. The fluidic control device of claim 15, wherein a longitudinal axis of the fluid inlet and a longitudinal axis of the fluid outlet align with the longitudinal axis of the deflectable membrane.

17. The fluidic control device of claim 15, wherein each of the first interior surface and the second interior surface are positioned substantially parallel to the deflectable membrane, and wherein the first interior surface is positioned closer to the deflectable membrane than the second interior surface, the fluidic control device further comprising:
an aperture positioned on the first interior surface of the first flow chamber between the fluid inlet and the first flow chamber.

18. A non-transitory computer readable medium having stored thereon instructions, that when executed by one or more processors, cause an additive manufacturing machine to create the fluidic control device of claim 15 such that the deflectable membrane is built concurrently with each of the other components of the fluidic control device.

19. The fluidic control device of claim 15, wherein the fluidic control device comprises a first fluidic control device module, the fluidic control device further comprising:
(a) a second fluidic control device module including (i) a third flow chamber in fluid communication with a second fluid inlet and a second fluid outlet, (ii) a control chamber, and (iii) a second deflectable membrane positioned between the third flow chamber and the control chamber, wherein the fluid outlet is in fluid communication with the second fluid inlet; and
(b) a third fluidic control device module including (i) a fourth flow chamber in fluid communication with a third fluid inlet, (ii) a fifth flow chamber in fluid communication with a third fluid outlet, and (iii) a third deflectable membrane positioned between the fourth flow chamber and the fifth flow chamber, wherein the deflectable membrane includes one or more perforations such that the fourth flow chamber is in fluid communication with the fifth flow chamber, and wherein the third fluid outlet is in fluid communication with the fluid outlet port.

20. A method comprising:
receiving fluid flow at a fluid inlet of a fluidic control device, wherein the fluidic control device comprises (i) a flow chamber in fluid communication with the fluid inlet and a fluid outlet, (ii) a control chamber in fluid communication with a control channel, (iii) a deflectable membrane positioned between the flow chamber and the control chamber, (iv) a housing surrounding the flow chamber, the control chamber, the fluid inlet, the fluid outlet, the deflectable membrane, and the control channel, (v) a fluid inlet port in fluid communication with the fluid inlet, (vi) a fluid outlet port in fluid communication with the fluid outlet, and (vii) a control input port in fluid communication with the control channel;
determining a desired fluid flow rate at the fluid outlet;
adjusting a pressure of the flow chamber such that the deflectable membrane changes a fluidic resistance of the flow chamber to achieve the desired flow rate at the fluid outlet.
